(19) United States
(12) Patent Application Publication
(10) Pub. No.: US 2014/0098109 A1
(43) Pub. Date: Apr. 10, 2014

(54) MOVABLE LAYER DESIGN FOR STRESS CONTROL AND STIFFNESS REDUCTION

(71) Applicant: QUALCOMM MEMS TECHNOLOGIES, INC., San Diego, CA (US)

(72) Inventors: Charles Chengyea Leu, Fremont, CA (US); Yi Tao, Fremont, CA (US); Fan Zhong, Fremont, CA (US)

(73) Assignee: QUALCOMM MEMS TECHNOLOGIES, INC., San Diego, CA (US)

(21) Appl. No.: 13/645,170

(22) Filed: Oct. 4, 2012

(51) Int. Cl. G06T 1/00; B05D 5/12; G02B 26/00

(52) U.S. Cl. 345/501; 359/290; 427/58

(57) ABSTRACT

Systems, methods and apparatuses reduce stress and/or reduce stiffness in a movable layer of an electromechanical systems (EMS) device. Stress or stiffness can be reduced by including one or more compressive stress layers to compensate for the tensile stress exhibited by other layers of the movable layer. The movable layer can include a dielectric core with a first tensile stress layer and a first compressive stress layer on a first side of the dielectric core, and a second tensile stress layer and a second compressive stress layer on a second side of the dielectric core.

### TECHNICAL FIELD

This disclosure relates to balancing stress in movables layers of electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

EMS devices, including interferometric modulators, include movable components, such as a movable layer. Operation of the device can include actuation of the movable layer between an unactuated and an actuated position. Movable layers can include multiple components or layers for different purposes. For example, some of the components or layers can help provide compensation for mismatches in coefficients of thermal expansion (CTE) between materials in the device. Some components or layers can provide reflective properties, for example in optical EMS devices. Some components can be used for other properties, such as conductivity or malleability. In some implementations, materials that are introduced for one or more functions can adversely affect other functions.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical systems (EMS) device. The device can include a substrate and a movable layer positioned over and spaced from the substrate. The movable layer can include a dielectric core; a first layer and a second layer positioned on a first side of the dielectric core; and a third layer and a fourth layer positioned on a second side of the dielectric core, opposite the first side. The first layer and the second layer can include a tensile stress layer and a compressive stress layer. The third layer and the fourth layer can also include a tensile stress layer and a compressive stress layer.

In some implementations, the EMS device can include a compressive stress layer including a material selected from SiO₂, AlNd, SiN, Si₃N₄, SiON, TiO₂, Ta₂O₅ and combinations thereof. In some implementations, at least one of the tensile stress layers is a metallic layer. In some implementations, the EMS device can include a fifth layer on the first side of the dielectric core and a sixth layer on the second side of the dielectric core. In some implementations, a first side of the dielectric core can include a same number of compressive stress layers and/or tensile stress layers as a second side of the dielectric core. In some implementations, the dielectric core contacts and is positioned between two tensile stress layers. In other implementations, the dielectric core contacts and is positioned between two compressive stress layers. In some implementations, the movable layer can include, in sequence, a first tensile stress layer; a first compressive stress layer; a dielectric core; a second tensile stress layer; and a second compressive stress layer. In some implementations, the movable layer can include, in sequence, a first compressive stress layer; a first tensile stress layer; a dielectric core; a second compressive stress layer; and a second tensile stress layer. In some implementations, a number and position of the compressive stress layers and the tensile stress layers are generally symmetrical about the core. In some implementations, a coefficient of thermal expansion of the dielectric core is between about 1×10⁻⁶/° C. and about 15×10⁻⁶/° C. In some implementations, the thickness of the dielectric core is about 40-100 nm. In some implementations, the dielectric core can include SiON.

Another innovative aspect of the subject matter described in this disclosure can be implemented in an EMS device including a substrate, a stationary layer positioned over the substrate and a movable layer spaced from the stationary layer by a gap. The movable layer can include a core layer in addition to a compressive stress layer and a tensile stress layer positioned on one side of the core layer. A stress and thickness of each of the tensile stress layer and the compressive stress layer cause an overall stress of the tensile stress layer and the compressive stress layer to be less than ±100 MPa.

In some implementations, the movable layer can further include a second tensile stress layer and a second compressive stress layer positioned on an opposite side of the core layer from the tensile stress layer and the compressive stress layer. A stress and thickness of each of the second tensile stress layer and the second compressive stress layer can cause an overall stress of the second tensile stress layer and the second compressive stress layer to be less than ±100 MPa.

Another innovative aspect of the subject matter described in this disclosure can be implemented in a method of manufacturing an EMS device. The method includes providing an EMS device having a substrate and a stationary electrode over the substrate. The method can also include forming a movable electrode over the stationary electrode. Forming the movable electrode includes forming a first layer and a second layer over the stationary electrode. The first and second layers include a tensile stress layer and a compressive stress layer. Forming the movable electrode also includes forming a dielectric core over the first and second layers. Forming the movable electrode also includes forming a third layer and a fourth layer over the dielectric core. The third and fourth layers include a tensile stress layer and a compressive stress layer.

In some implementations, the method of manufacturing an EMS device can further include forming additional pairs of layers around the dielectric core. In some implementations, forming the first, second, third, and fourth layers can include adjusting a stress of the movable layer. In some implementations, forming the movable electrode can include symmetrically providing compressive stress and tensile stress layers over and under the dielectric core. In some implementations, forming the first layer and the second layer can produce a net stress less than about ±100 MPa. In some implementations, forming the third layer and the fourth layer can produce a net stress less than about ±100 MPa.

Another innovative aspect of the subject matter described in this disclosure can be implemented in an EMS device including a substrate and a movable layer positioned over and spaced from the substrate. The movable layer includes a means for compensating for thermal expansion between the movable layer and the substrate. The movable layer also includes a means for electrical conducting and a means for compensating for stress introduced by the conductive means.

In some implementations, the means for compensating for thermal expansion can include a dielectric core layer. In some implementations, the means for compensating for stress can include a compressive stress layer. In some implementations, the means for electrical conducting can include a tensile stress layer.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIGS. 2A-2E are cross-sectional illustrations of varying implementations of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIG. 5 is a cross-sectional illustration of an implementation of an electromechanical systems (EMS) device.

FIG. 6 is a cross-sectional illustration of another implementation of an electromechanical systems (EMS) device.

FIGS. 7A-7E are illustrations of varying implementations of a movable layer of an electromechanical systems (EMS) device.

FIG. 8 is a flow diagram illustrating an implementation of a manufacturing process for an electromechanical systems (EMS) device.

FIGS. 9A and 9B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Operation of electromechanical systems devices can include actuating a movable layer between an unactuated position, during which the movable layer is spaced from a substrate by a gap, and an actuated position, during which the movable layer moves towards the substrate. The movable layer can include a tensile mirror layer on one side of a dielectric core layer and another tensile stress layer can be positioned on the other side of the dielectric core layer. Tensile stress can refer to a stress occurring in the material when an object is subjected to pulling or stretching force, which makes the object bigger. The object with internal tensile stress tends to return to its stress-free shape and exerts on its boundary an inward force toward the center of the object. A layer of material that is connected between two points and has an internal tensile stress can effectively pull inward on the two points, which makes the layer stiffer and harder to bend. On the other hand, compressive stress can refer to a stress occurring in the material when an object is subjected to pushing or squeezing force, which makes the object smaller. The object with internal compressive stress tends to return to its stress-free shape and exerts on its boundary an outward force toward the sides of the object. A layer of material that is connected between two points and has an internal compressive stress can effectively push outward towards the two points, which makes the layer softer and easier to bend.

Tensile stress can be responsible for a significant portion of the stiffness of the movable layer. One or more compressive stress layers can be added around the dielectric core in order to reduce the stiffness of the movable layer.

Particular implementations of the subject matter described in this disclosure can be implemented to realize one or more of the following potential advantages. The dielectric core layer can compensate for thermal expansion of the substrate, but can add to the tensile stress of the movable layer. Adding in one or more compressive stress layers can reduce the tensile stress on one or both sides of the dielectric core, which in turn can reduce the stiffness of the movable layer can and decrease the voltage used to actuate the movable layer. Certain electromechanical systems (EMS) devices, such as smartphones, may employ a large gap between a movable layer and a substrate, requiring a high actuation voltage to move the movable layer towards the substrate. Adding in one or more compressive stress layers can help offset the increase in voltage and make actuation of a movable layer in a high gap device more feasible.

An example of a suitable EMS or MEMS device or apparatus, to which the described implementations may apply, is an optical EMS device, such as a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

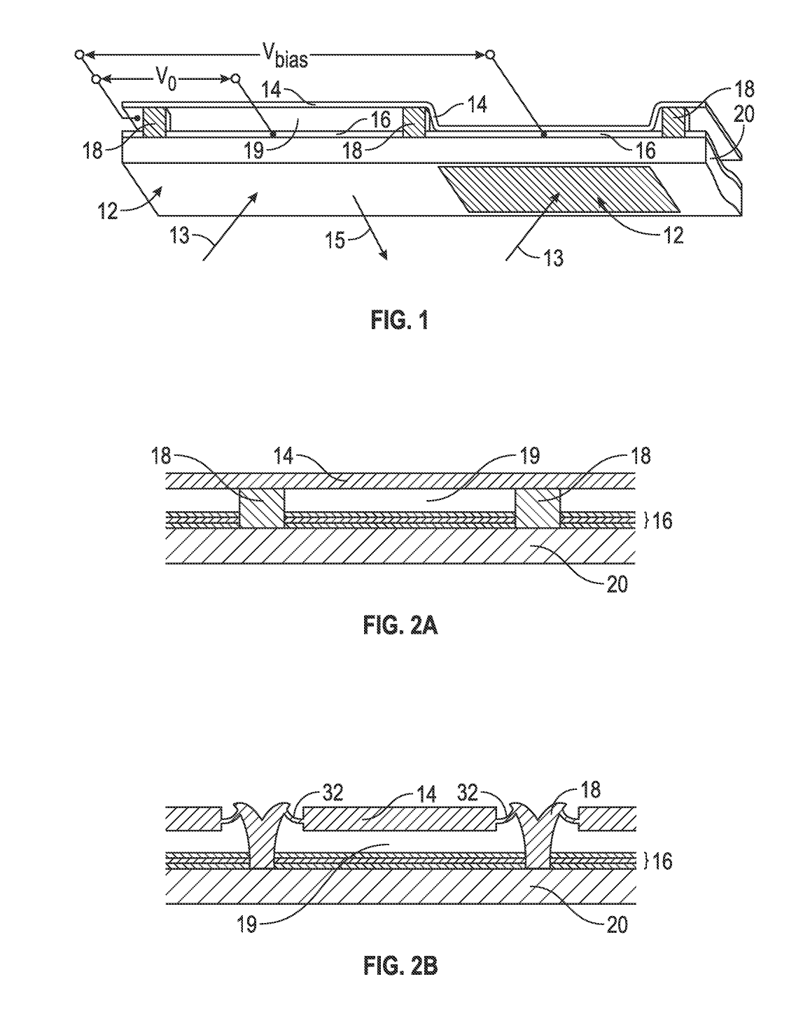

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of primary colors and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer. A conductive layer of the optical stack 16, such as a metallic optically absorptive layer, can serve as a stationary electrode structure for an EMS device.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be less than approximately 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

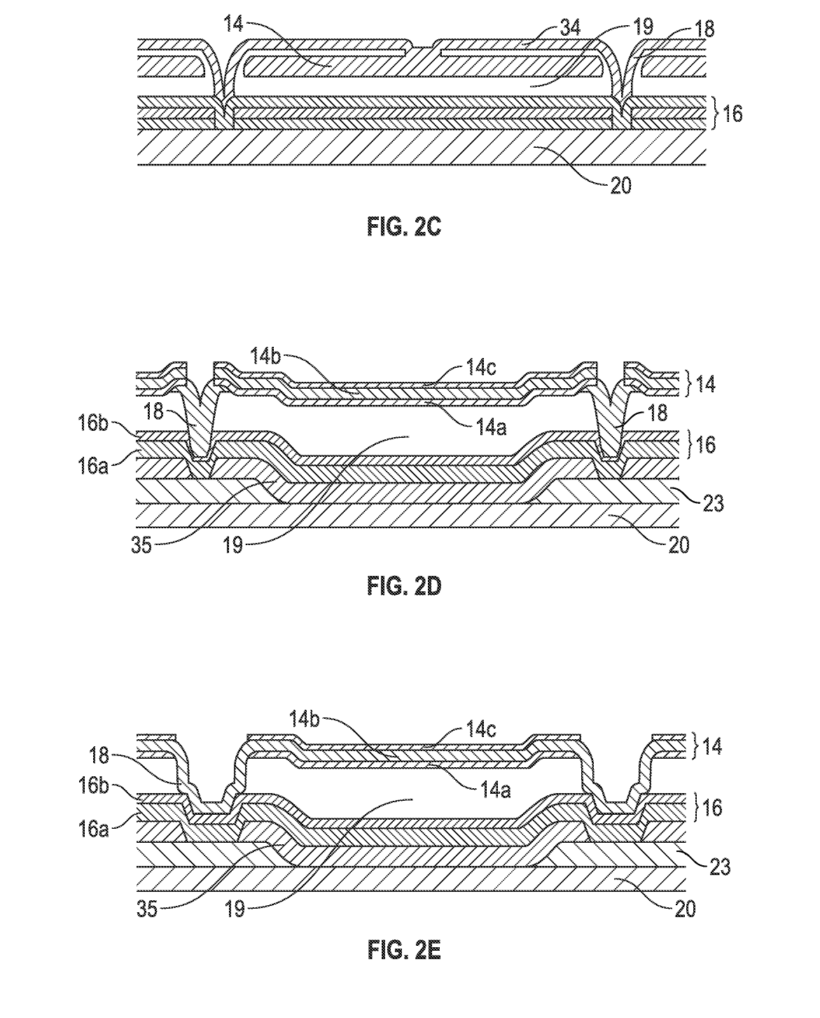

The details of the structure of IMOD displays and display elements may vary widely. FIGS. 2A-2E are cross-sectional illustrations of varying implementations of IMOD display elements. FIG. 2A is a cross-sectional illustration of an IMOD display element, where a strip of metal material is deposited on supports 18 extending generally orthogonally from the substrate 20 forming the movable reflective layer 14. In FIG. 2B, the movable reflective layer 14 of each IMOD display element is generally square or rectangular in shape and attached to supports 18 at or near the corners, on tethers 32. In FIG. 2C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 2C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 2D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂), and can also be referred to as a dielectric core layer. In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 2D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 2E is another cross-sectional illustration of an IMOD display element, where the movable reflective layer 14 is self-supporting. While FIG. 2D illustrates support posts 18 that are structurally and/or materially distinct from the movable reflective layer 14, the implementation of FIG. 2E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 2E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 2A-2E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 2C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

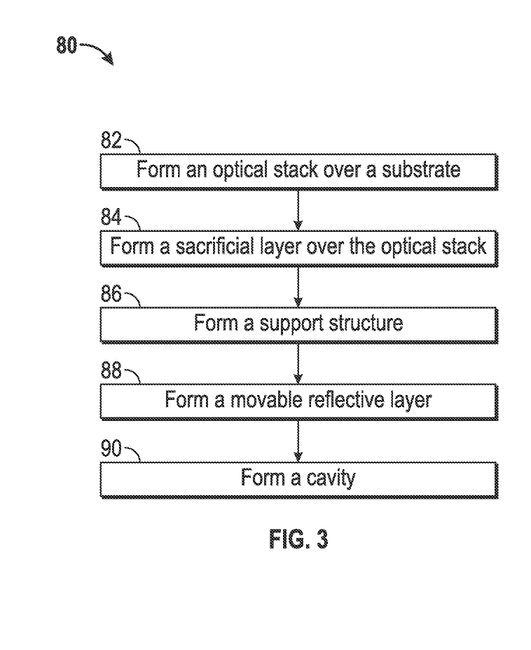

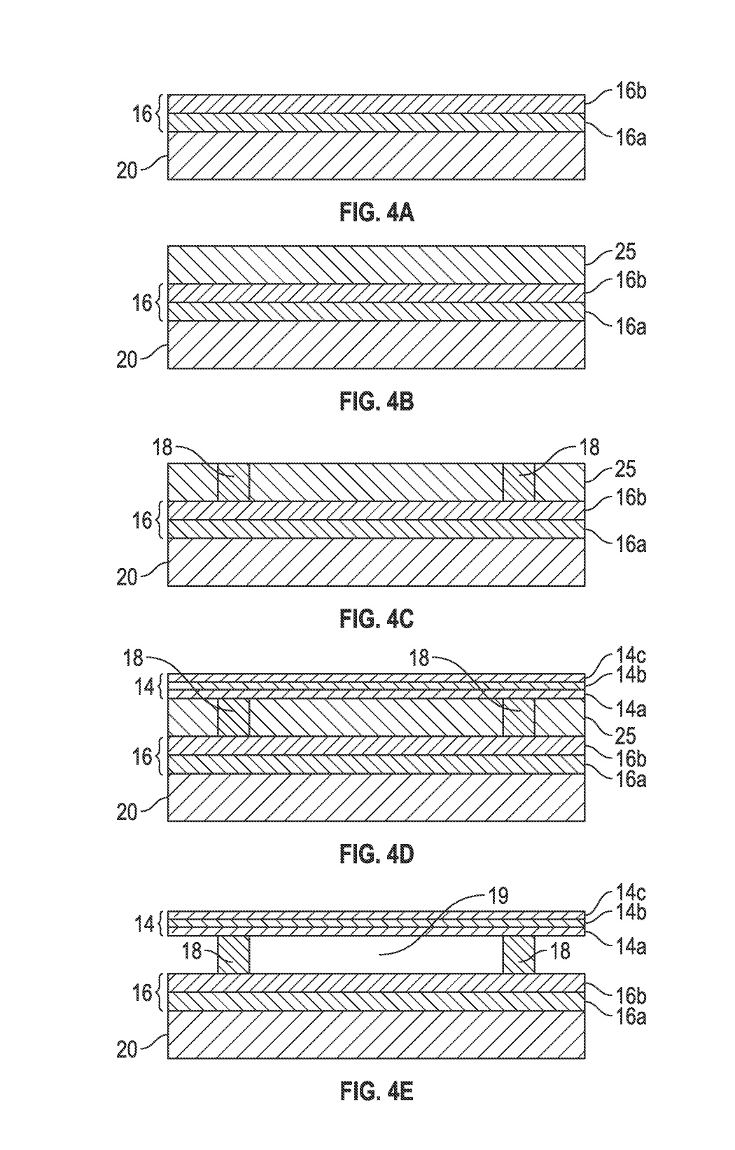

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a fluorine-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 4D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include metallic layers selected for their optical (e.g., reflective) and/or conductive properties, and another sub-layer 14b may include a mechanical sub-layer selected for its mechanical properties. In some implementations, the mechanical sub-layer may include a dielectric material. In some implementations, the posts 18 can be simultaneously formed, as in the self-supporting implementation of FIG. 2E. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

Electromechanical systems (EMS) devices can include a movable layer, like the movable reflective layer 14 depicted in FIGS. 1, 2A-2E and 4A-4E that can move between an open position, spaced from a substrate, and a closed position. For example, the open position can be the relaxed position, and the closed position can be the result of actuation. Actuating the movable layer can result from applying a voltage to the movable layer. Stiffer layers can entail a higher voltage to cause the movable layer to move. In some implementations, electromechanical systems (EMS) devices include a movable layer with a dielectric core. The dielectric core can be positioned between two tensile stress layers. For example, in an IMOD implementation, the dielectric core can be positioned between a tensile reflective layer (e.g., similar to layer 14a, described with respect to FIGS. 2D-2E and 4A-4E) and a tensile conductive layer (e.g., similar to layer 14c described with respect to FIGS. 2D-2E and 4A-4E). In some implementations, the dielectric core and the two tensile stress layers can exhibit a high tensile stress, particularly after being annealed.

The dielectric core and its thickness may be selected to compensate for thermal expansion of the substrate. For example, in some implementations a SiON dielectric core can have a coefficient of thermal expansion (CTE) of about 1×10⁻⁶/° C.-15×10⁻⁶/° C. For example, in some implementations a dielectric core can have a CTE of about 2×10⁻⁶/° C.-3×10⁻⁶/° C. A glass substrate can have a coefficient of thermal expansion in the same range. For example, in some implementations, the substrate can have a CTE of about 3×10⁻⁶/° C.-5×10⁻⁶/° C. However, the relatively thick dielectric core, selected to match CTE with the substrate, can add to the tensile stress of the metallic layers in the movable layer.

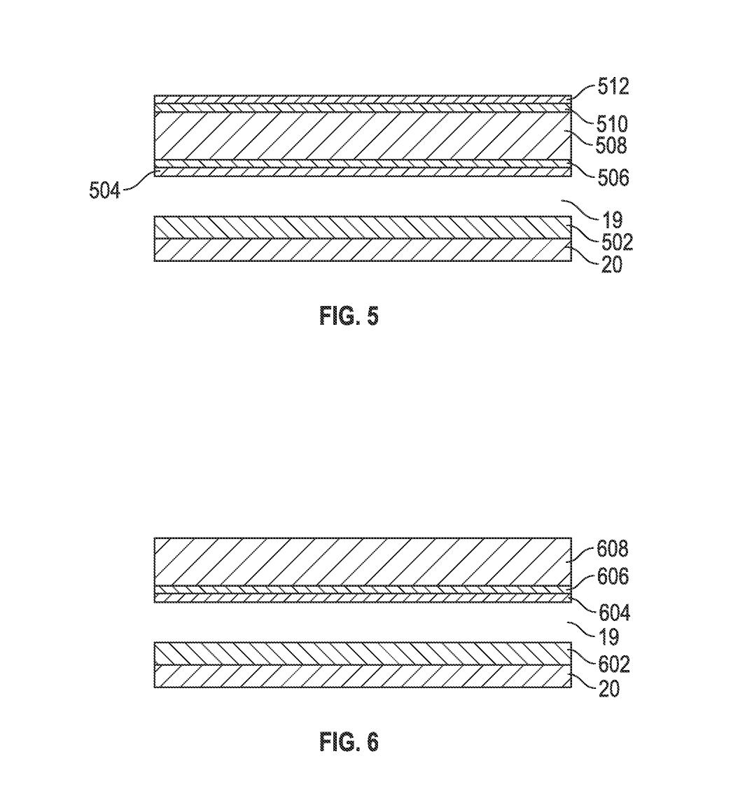

FIG. 5 is a cross-sectional illustration of an implementation of electromechanical systems (EMS) device. The device includes a stationary layer 502 and a movable layer 503 positioned over a substrate 20. The stationary layer 502 can include a stationary electrode and other layers, such as the dielectric 16b of the optical stack 16 described above. The movable layer 503 is spaced from the substrate 20 and the stationary layer 502 by a gap 19. The movable layer 503 includes a first layer 504 and a second layer 506 positioned on a first side of a dielectric core 508. The movable layer 503 also includes a third layer 510 and a fourth layer 512 positioned on a second side of the dielectric core 508. The first and second layers 504 and 506 can include a tensile stress layer and a compressive stress layer. For example, the first layer 504 can be a tensile stress layer and the second layer 506 can be a compressive stress layer, or vice versa. The third and fourth layers 510 and 512 can also include a tensile stress layer and a compressive stress layer. For example, the third layer 510 can be a compressive stress layer and the fourth layer 512 can be a tensile stress layer, or vice versa.

In some implementations, the movable layer 503 includes at least one tensile stress layer, which can be electrically conductive, such as a metallic layer. The tensile stress layer(s) can include Al in some implementations. For example, the tensile stress layer(s) can include aluminum copper (AlCu). AlCu can have a stress of around +300-+500 MPa. Other materials are also possible. In some implementations, the tensile stress layer can have a stress between +50-+950 MPa. In some implementations, the tensile stress layer(s) are not conductive, for example in an aluminum oxynitride (AlOₓN_{y}) layer. In some implementations, a thickness of each tensile stress layer is about 10-30 nm. In some implementations, the material comprising each tensile stress layer is selected to have a stress to counter stresses introduced by other layers in the movable layer 503. In some implementations, the thickness of each tensile layer is selected to counter stresses introduced by other layers of the movable layer 503. In some implementations, a movable layer can include multiple tensile stress layers including the same materials. In other implementations, a movable layer can include multiple tensile stress layers including different materials.

In some implementations, the movable layer 503 includes at least one compressive stress layer, which can be a dielectric material, such as silicon oxide (SiO₂), silicon nitride (SiN), silicon nitride (Si₃N₄), SiON. SiO₂, for example, can have a compressive stress of about −350-−250 MPa. Other materials are also contemplated. In other implementations, the compressive stress layer(s) can be electrically conductive, such as aluminum neodymium (AlNd), titanium dioxide (TiO₂) and tantalum pentoxide (Ta₂O₅). AlNd, for example, can have a compressive stress of about −250-−150 MPa. In some implementations, a movable layer can include multiple compressive stress layers including the same materials. In other implementations, a movable layer can include multiple compressive stress layers including different materials. In some implementations, each compressive stress layer has a thickness of about 10-90 nm. In some implementations, each compressive stress layer has a thickness of about 5 nm-1 μm.

The dielectric core can include SiON, in some implementations. SiON can have a tensile stress of around 40-80 MPa. Other materials are also contemplated. In some implementations, the dielectric core is a layer with a thickness of about 40-110 nm.

Stress refers to average force per unit area. The dimensions of layers within the movable layer can be nearly the same, except for thickness of the layers. Accordingly, the thickness of each individual layer can determine how greatly the stress of the individual layer will influence the stress of the overall movable layer. For example, even though the SiON can be less tensile than AlCu, if the SiON layer is thicker, its tensile stress is magnified by a greater number than the tensile stress of the AlCu when determining an overall stress of the movable layer.

FIG. 6 is a cross-sectional illustration of another implementation of an electromechanical systems (EMS) device. The device includes a stationary layer 602 and a movable layer 603 positioned over a substrate 20. The stationary layer 602 can include a stationary electrode and other layers, such as the dielectric 16b of the optical stack 16 described above. The movable layer 603 is spaced from the substrate 20 and the stationary layer 602 by a gap 19. The movable layer includes a core layer 608 and a tensile stress layer and a compressive stress layer on one side of the core layer 608. The implementation of FIG. 6 depicts a compressive stress layer 604; a tensile stress layer 606 positioned over the compressive stress layer 604; and a core layer 608 positioned over the compressive stress layer 604. The thickness and stress of each of the tensile stress layer and the compressive stress layer can be selected to approximately balance an overall stress of the pair of layers. For example, in some implementations, the stress and thickness of each of the tensile stress layer and the compressive stress layer can be selected to produce an overall stress of the pair of layers of less than about ±100 MPa. In some implementations, the stress and thickness of each of the tensile stress layer and the compressive stress layer can cause an overall stress of the pair of layers to be less than ±50 MPa. A positive stress value refers to a tensile stress, while a negative stress value refers to a compressive stress. In some implementations, the stresses of adjacent layers are balanced within the resolution limits of available stress measurement technology. For example, FP-2320-S Thin Film Stress Measurement Systems™ commercially available from Toho Technology Corporation of Nagoya, Japan have a resolution of ±2.5% or ±1 MPa, whichever is larger; higher resolution can be obtained using X-ray diffraction techniques.

In some implementations, the core layer is surrounded by two pairs of stress-balanced layers. For example, the core layer can have a first tensile and compressive stress layer pair on one side and a second tensile and compressive stress layer pair on the other side. In some implementations, the stress and thickness of each of the tensile stress layer and the compressive stress layer can cause an overall stress of each pair of stress-balanced layers to be less than about ±100 MPa on either side of the core layer. In some implementations, the stress and thickness of each of the tensile stress layer and the compressive stress layer can cause an overall stress of each pair of stress-balanced layers to be less than about ±50 MPa on either side of the core layer.

In some implementations, the tensile and compressive stress layers surrounding the core layer can reduce a tensile stress of the overall movable layer relative to the absence of the compressive stress layers. For example, in a layer including a tensile core and two tensile stress layers, the thickness and stress of the compressive stress layers can be selected to balance out the tensile stress contributed by the tensile stress layers and the tensile core. In some implementations, the stress and thickness of each of the layers of the movable layer can cause an overall stress of the movable layer to be +30-+100 MPa. In some implementations, the core layer can be a compressive layer. Tensile stress layers can be added around a compressive core layer to balance out the tensile stress contributed by the compressive core and any other compressive layers in the movable layer.

In some implementations, a first side of the core layer can include the same number of compressive stress layers as the second side of the core layer. In some implementations, a first side of the core layer can include the same number of tensile stress layers as the second side of the core layer. In some implementations, a first side of the core layer can include the same number of tensile stress layers and compressive stress layers as the second side of the core layer. In some implementations, a first side of the core layer can include a different number of tensile stress layers and/or compressive stress layer as the second side of the core layer.

In some implementations, the tensile and compressive stress layers are symmetric about the dielectric core. For example, an opposing pair of compressive stress layers can be positioned on opposites sides of, or surround, the dielectric core and an opposing pair of tensile stress layers can be positioned on opposite sides of, or surround, the opposing pair of compressive stress layers or vice versa. In some implementations, additional pairs of symmetrically positioned compressive stress layers and/or tensile stress layers may be positioned about the dielectric core. For example, a movable layer can include an inner dielectric core positioned between a pair of compressive stress layers, which can be positioned between an opposing pair of tensile stress layers, which can be positioned between an opposing pair of compressive stress layers. In some implementations, symmetry can simply refer to the position and the classification of a layer as tensile or compressive and need not refer to the specific material and thickness of the tensile or compressive layer. In other implementations, the opposing layers can be symmetrical in position as well as material and/or thickness.

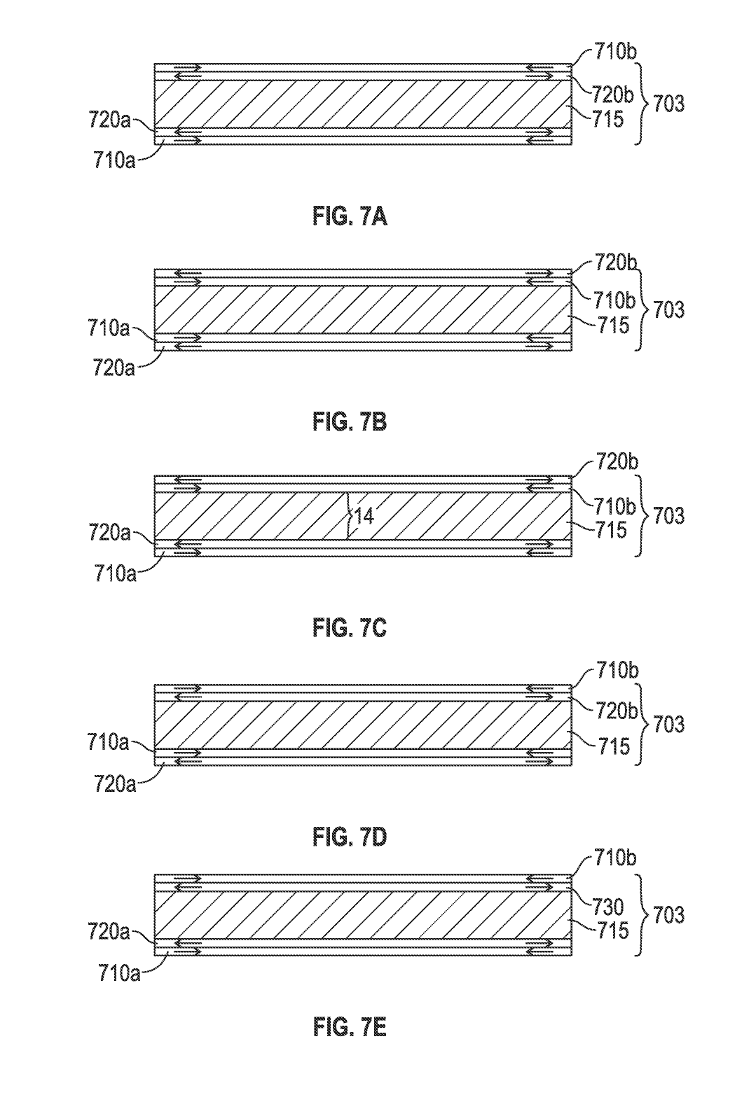

FIGS. 7A-7E are illustrations of varying implementations of a movable layer of an electromechanical systems (EMS) device. In some implementations, the number and positions of the compressive stress layers and the tensile stress layers can be symmetric about the dielectric core. For example, FIG. 7A depicts a movable layer 703 of an EMS device, including a first tensile stress layer 710a; a first compressive stress layer 720a positioned over and contacting the first tensile stress layer 710a; a dielectric core 715 positioned over and contacting the first compressive stress layer 720a; a second compressive stress layer 720b positioned over and contacting the dielectric core 715; and a second tensile stress layer 710b positioned over and contacting the second compressive stress layer 720b. FIG. 7A is an example of a symmetrical arrangement of tensile and compressive layers about the dielectric core.

FIG. 7B depicts another example of a movable layer of an EMS device in which a number and position of the compressive stress layers and the tensile stress layers are symmetric about the dielectric core. The movable layer 703 of FIG. 7B includes a first compressive stress layer 720a; a first tensile stress layer 710a positioned over and contacting the first compressive stress layer 720a; a dielectric core 715 positioned over and contacting the first tensile stress layer 710a; a second tensile stress layer 710b positioned over and contacting the dielectric core 715; and a second compressive stress layer 720b positioned over and contacting the second tensile stress layer 710b. FIG. 7B is an example of another symmetrical arrangement of tensile and compressive layers about the dielectric core.

In some implementations, the compressive stress layers and the tensile stress layers are not symmetric about the dielectric core. For example, FIG. 7C depicts an example of a movable layer 703 of an EMS device including a first tensile stress layer 710a; a first compressive stress layer 720a positioned over and contacting the first tensile stress layer 710a; a dielectric core 715 positioned over and contacting the first compressive stress layer 720a; a second tensile stress layer 710b positioned over and contacting the dielectric core 715; and a second compressive stress layer 720b positioned over and contacting the second tensile stress layer 710b. In this implementation, the dielectric core 715 is positioned between and contacts the second tensile stress layer 710b and the first compressive stress layer 720a. Thus, the layers are not symmetric about the dielectric core.

FIG. 7D depicts another example of a movable layer 703 of an EMS device that is not symmetric about the dielectric core. The movable layer 703 of FIG. 7D includes a first compressive stress layer 720a; a first tensile stress layer 710a positioned over and contacting the first compressive stress layer 720a; a dielectric core 715 positioned over and contacting the first tensile stress layer 710a; a second compressive stress layer 720b positioned over and contacting the dielectric core 715; and a second tensile stress layer 710b positioned over and contacting the second compressive stress layer 720b. FIG. 7D is an example of an asymmetrical arrangement of tensile and compressive layers about the dielectric core.

FIG. 7E depicts an implementation of a movable layer in which the compressive stress layers and tensile stress layers are symmetric about the dielectric core in a stress sense but not in a materials sense. In this implementation, the compressive stress layers include different materials. The movable layer of FIG. 7E includes a first tensile stress layer 710a; a first compressive stress layer 720a including SiO₂ positioned over and contacting the first tensile stress layer 710a; a dielectric core 715 positioned over and contacting the compressive stress layer 720a; a second compressive stress layer 730 including AlNd positioned over the dielectric core 715; and a second tensile stress layer 710b positioned over the compressive stress layer 730. The compressive stress layer 730, including AlNd, is an example of an electrically conductive compressive stress layer. FIG. 7E is an example of a symmetrical arrangement of tensile and compressive layers about the dielectric core, in which the layers are asymmetrical with respect to materials.

In IMOD implementations of the movable layers described above, the different layers can provide different functions. For example, the lower tensile stress layer can function as an EMS electrode and a reflective layer. The core can serve as a support layer and compensate for thermal expansion of the substrate. The upper tensile stress layer can balance stresses of the lower tensile stress layer to make the movable layer symmetrical and can also be used for routing signals. The lower and upper compressive stress layers can compensate for the stress of the tensile stress layers.

In IMOD implementations of the EMS devices described above, the movable layers are spaced from the substrate by a gap, the size of which determines which color is interferometrically reflected by the particular EMS device. Gap sizes can range from about 100 nm-600 nm, in an unbiased state. For example, an IMOD that is configured to reflect the color green can have a gap size of about 460-500 nm. EMS devices with high gap sizes, for example gap sizes greater than 400 nm, can utilize stress balancing and/or reducing in their movable layers to lower actuation voltage.

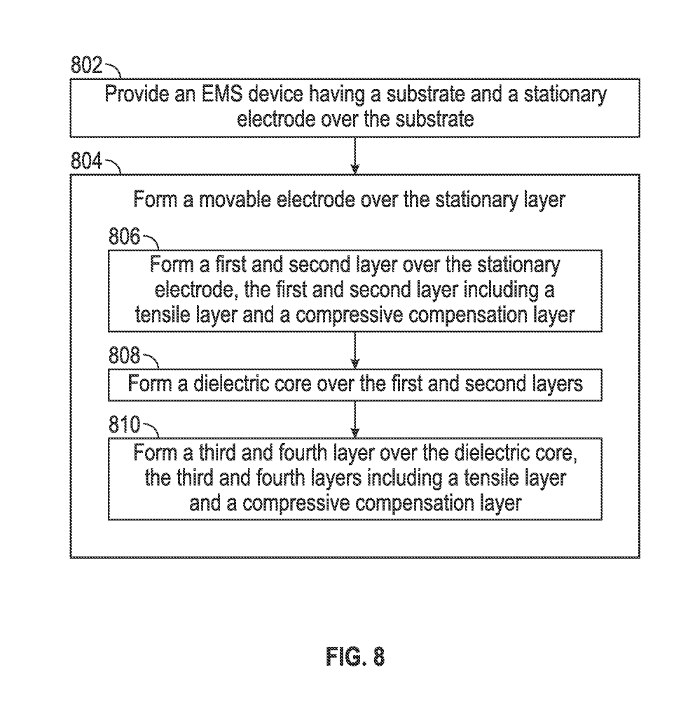

FIG. 8 is a flow diagram illustrating an implementation of a manufacturing process for an electromechanical systems (EMS) device. The process includes providing an EMS device having a substrate and a stationary electrode over the substrate, as depicted in block 802. The process can further include forming a movable electrode over the stationary electrode, as illustrated at block 804. Forming a movable electrode over the stationary electrode can include forming a first and second layer over the first electrode, as depicted at block 806. The first and second layer can include a tensile stress layer and a compressive stress layer. Forming a movable electrode over the stationary electrode can further include forming a dielectric core over the first and second layers, as illustrated at block 808. Forming a movable electrode over the stationary electrode can also include forming a third and fourth layer over the dielectric core, as shown at block 810. The third and fourth layers can include a tensile stress layer and a compressive stress layer.

In some implementations, forming the first, second, third, and fourth layers about the dielectric core can include adjusting a stress of the movable layer. For example, forming the first, second, third, and fourth layers can reduce an overall tensile stress of the movable layer relative to the absence of the compressive stress layers. In some implementations, forming the first, second, third, and fourth layers can cause an overall stress of the movable layer to be +30 MPa-+100 MPa.

In some implementations, the method can further include forming additional layers around the dielectric core. For example an additional layer can be added to one side of the dielectric core or opposing pairs of layers can be added to either side of the dielectric core. In some implementations three additional layers or two opposing pairs of layers can be added. Additional layers are also contemplated. In some implementations adjacent layers can be of differing types of stress. For example a tensile stress layer can be positioned adjacent to and contacting a compressive layer. In some implementations, adjacent layers can be of the same type of stress. For example, a tensile stress layer can be positioned adjacent to and contacting another tensile stress layer. For another example, a compressive layer can be positioned adjacent to and contacting another compressive layer.

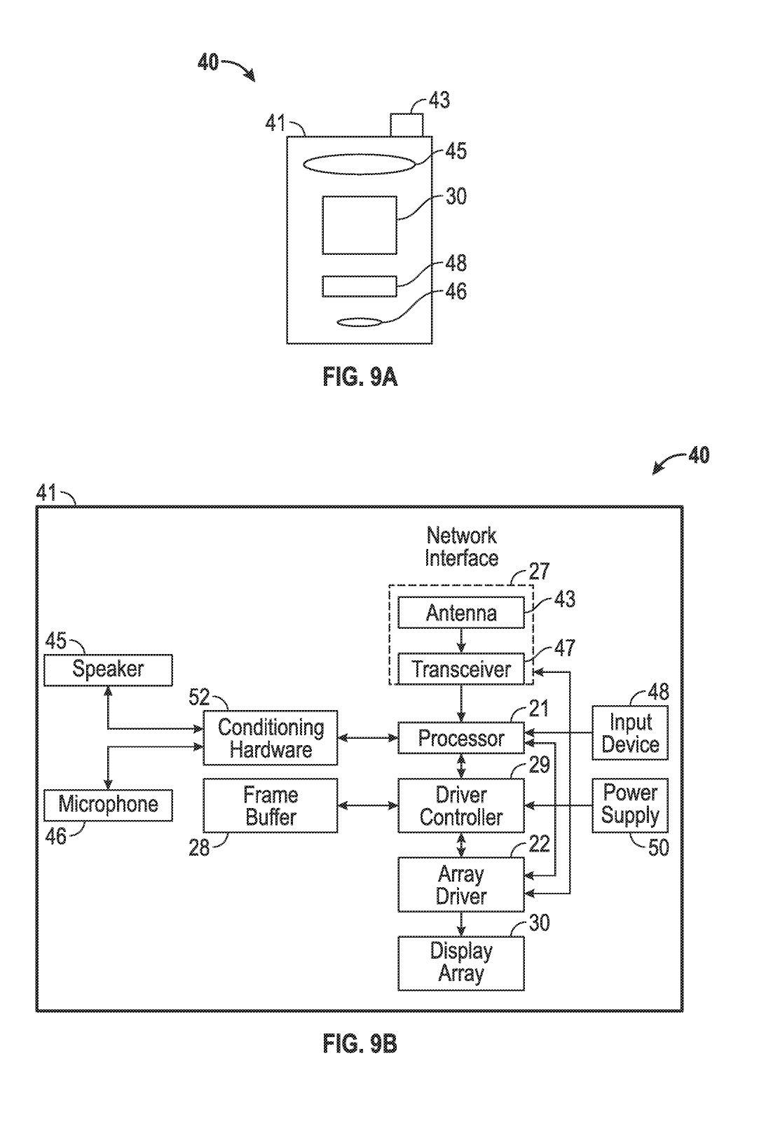

FIGS. 9A and 9B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 9A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3 G, 4 G or 5 G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems (EMS) device comprising:
a substrate; and
a movable layer positioned over and spaced from the substrate, the movable layer including:
a dielectric core;
a first layer and a second layer positioned on a first side of the dielectric core; and
a third layer and a fourth layer positioned on a second side of the dielectric core, opposite the first side,
wherein the first layer and the second layer includes a tensile stress layer and a compressive stress layer and the third layer and the fourth layer includes a tensile stress layer and a compressive stress layer.

2. The EMS device of claim 1, wherein each of the compressive stress layers includes a material selected from SiO₂, AlNd, SiN, Si₃N₄, SiON, TiO₂, Ta₂O₅ and combinations thereof.

3. The EMS device of claim 1, wherein at least one of the tensile stress layers is a metallic layer.

4. The EMS device of claim 1, further including a fifth layer on the first side of the dielectric core and a sixth layer on the second side of the dielectric core.

5. The EMS device of claim 1, wherein the first side of the dielectric core includes a same number of compressive stress layers as the second side of the dielectric core.

6. The EMS device of claim 1, wherein the first side of the dielectric core includes a same number of tensile stress layers as the second side of the dielectric core.

7. The EMS device of claim 1, wherein the dielectric core contacts and is positioned between two compressive stress layers.

8. The EMS device of claim 1, wherein the dielectric core contacts and is positioned between two tensile stress layers.

9. The EMS device of claim 1, wherein the movable layer includes, in sequence:
a first tensile stress layer;
a first compressive stress layer;
the dielectric core;
a second tensile stress layer; and
a second compressive stress layer.

10. The EMS device of claim 1, wherein the movable layer includes, in sequence:
a first compressive stress layer;
a first tensile stress layer;
the dielectric core;
a second compressive stress layer; and
a second tensile stress layer.

11. The EMS device of claim 1, wherein a number and a position of the compressive stress layers and the tensile stress layers are generally symmetrical about the core.

12. The EMS device of claim 1, wherein a coefficient of thermal expansion of the dielectric core is between about 1×10⁻⁶/° C. and about 15×10⁻⁶/° C.

13. The EMS device of claim 12, wherein a thickness of the dielectric core is between about 40 nm and about 110 nm.

14. The EMS device of claim 12, wherein the dielectric core includes SiON.

15. The EMS device of claim 1, wherein the EMS device further includes a post for supporting the movable layer and spacing the movable layer from the substrate.

16. The EMS device of claim 15, wherein the post is integrated with the movable layer.

17. A display apparatus including:
the EMS device of claim 1;
a display;
a processor that is configured to communicate with the display, the processor being configured to process image data; and
a memory device that is configured to communicate with the processor.

18. The display apparatus of claim 17, including an array of EMS devices like the EMS device of claim 1, wherein the EMS devices are interferometric modulators.

19. An electromechanical systems (EMS) device comprising:
a substrate;
a stationary layer positioned over the substrate; and
a movable layer spaced from the stationary layer by a gap, wherein the movable layer includes:
a core layer; and
a tensile stress layer and a compressive stress layer positioned on one side of the core, wherein a stress and thickness of each of the tensile stress layer and the compressive stress layer cause an overall stress of the tensile stress layer and the compressive stress layer to be less than ±100 MPa.

20. The EMS device of claim 19, wherein the movable layer further includes:
a second tensile stress layer and a second compressive stress layer positioned on an opposite side of the core layer from the tensile stress layer and the compressive stress layer, wherein a stress and thickness of each of the second tensile stress layer and the second compressive stress layer cause an overall stress of the second tensile stress layer and the second compressive stress layer to be less than ±100 MPa.

21. The EMS device of claim 20, wherein at least one of the tensile stress layers includes a metal.

22. A method of manufacturing an electromechanical systems apparatus (EMS) device, comprising:
providing an EMS device having a substrate and a stationary electrode over the substrate;
forming a movable electrode over the stationary electrode, wherein forming the movable layer includes:
forming a first layer and a second layer over the stationary electrode, the first and second layers including a tensile stress layer and a compressive stress layer;
forming a dielectric core over the first and second layers; and
forming a third layer and a fourth layer over the dielectric core, the third and fourth layers including a tensile stress layer and a compressive stress layer.

23. The method of claim 22, further comprising forming additional pairs of layers around the dielectric core.

24. The method of claim 22, wherein forming the first, second, third, and fourth layers of the movable layer includes adjusting a stress of the movable layer.

25. The method of claim 22, wherein forming the movable electrode includes symmetrically providing compressive stress and tensile stress layers over and under the dielectric core.

26. The method of claim 22, wherein forming the first layer and the second layer produces a net stress less than about ±100 MPa.

27. The method of claim 26, wherein forming the third layer and the fourth layer produces a net stress less than about ±100 MPa.

28. An electromechanical systems (EMS) device comprising;
a substrate; and
a movable layer positioned over and spaced from the substrate, the movable layer including:
a means for compensating for thermal expansion between the movable layer and the substrate;
a means for electrical conducting; and
a means for compensating for stress introduced by the conductive means.

29. The EMS device of claim 28, wherein the means for compensating for thermal expansion includes a dielectric core layer.

30. The EMS device of claim 28, wherein the means for compensating for stress includes a compressive stress layer.

31. The EMS device of claim 28, wherein the means for electrical conducting includes a tensile stress layer.
